(19) United States
(12) Patent Application Publication
(10) Pub. No.: US 2019/0005739 A1
(43) Pub. Date: Jan. 3, 2019

(54) SYSTEMS AND METHODS FOR ARRANGING PARKING BETWEEN PARTIES USING COMPUTING DEVICES

(71) Applicant: Parking Gurus LLC, Phoenix, AZ (US)

(72) Inventors: Richard Gazlay, Phoenix, AZ (US); Sheldon Goldberg, Jacksonville, FL (US)

(21) Appl. No.: 16/104,482

(22) Filed: Aug. 17, 2018

Related U.S. Application Data
(63) Continuation-in-part of application No. 15/807,062, filed on Nov. 8, 2017.
(60) Provisional application No. 62/420,081, filed on Nov. 10, 2016.

(51) Int. Cl. G07B 15/02; G01C 21/34; G01C 21/36; G06Q 30/06

(52) U.S. Cl. CPC G07B 15/02; G01C 21/3476; G06Q 30/0625; G01C 21/3608; G06Q 30/0645; G01C 21/3673

(57) ABSTRACT

A parking system may register a parking spot to a user account in response to a registration request from a first user device. The parking spot may be associated with parking descriptors such as, for example, GPS location, an address, and/or other attributes of the parking spot. The system may receive a street address data and associate the street address data with the parking spot, wherein the association is a one-to-many association with each of a plurality of parking spots associated with the street address data. The system may receive a query along with search criteria from a second user device. The parking spot may be selected by matching the search criteria to the parking descriptor, for example, using a database query. The system may return the parking spot to the second user device and/or display a search result interface on the second user device. The search result interface may include a parking icon associated with the parking spot and located on a map based on the location of the parking spot.

### CROSS-REFERENCE TO RELATED APPLICATIONS

This application is a continuation-in-part of U.S. application Ser. No. 15/807,062 entitled “SYSTEMS AND METHODS FOR ARRANGING PARKING BETWEEN PARTIES USING COMPUTING DEVICES” filed on Nov. 8, 2017. U.S. application Ser. No. 15/807,062 claims priority to, and the benefit of, U.S. Provisional Application Ser. No. 62/420,081 entitled “SYSTEMS AND METHODS FOR ARRANGING PARKING BETWEEN PARTIES USING COMPUTING DEVICES” filed on Nov. 10, 2016. The entire contents of each of the foregoing references are incorporated by reference herein for all purposes.

### TECHNICAL FIELD

The present disclosure relates to systems and methods for arranging use of a parking spot between parties using computing devices.

### BACKGROUND

Land comes at a premium in dense areas. Drivers struggle to park their cars in big cities everywhere. In places like New York City, people can rent spaces for fairly high prices. The rent only gets a single space at a single location; a spot at the apartment doesn't translate to parking for a game at Madison Square Garden. In places like Los Angeles, people can buy passes from garage companies that can be used. The garages may have multiple locations, but they are also subject to filling up. A closed garage does the subscriber no good. Street parking in these big cities can feel non-existent.

In busy urban areas, locating a parking spot typically results from a fortuitous blend of luck and timing. Drivers occasionally get lucky and find a hidden parking spot at their destination, but searching takes time. Once a reliable and regularly vacant spot is located, they are incentivized to guard the location as a secret. Drivers can do little to reduce time spent looking for parking. It can be difficult for drivers to locate parking with desired amenities in a given location in advance of the need for parking. Further, when searching for parking, it can be difficult or even unlawful to manually type in details of a desired parking spot on a mobile electronic device while driving. Accordingly, improved systems and methods for arranging parking remain desirable.

### SUMMARY

In an exemplary embodiment, a system, method, and computer readable medium (collectively, the “system”) are disclosed for matching parking spots to drivers searching for parking spots. The system may register a parking spot to a user account in response to a registration request from a first user device. The parking spot may be associated with parking descriptors such as, for example, GPS location, an address, and/or other attributes of the parking spot. The system may receive street address data and associate the street address data with the parking spot, wherein the association is a one-to-many association with each of a plurality of parking spots associated with the street address data. The system may receive a query along with search criteria from a second user device. The parking spot may be selected by matching the search criteria to the parking descriptor, for example, using a database query. The system may return the parking spot to the second user device and/or display a search result interface on the second user device. The search result interface may include a parking icon associated with the parking spot and located on a map based on the location of the parking spot.

In various embodiments, the system may receive a request from the second user device to rent the parking spot for a selected time. The system may deliver to the second user device, a message confirming rental of the parking spot to the second user account for the selected period of time. The system may receive from the second user account, payment for the rental of the parking spot for the selected period of time. In various embodiments, the system may send a message to the second user device, the message indicating that the allocated rental time for the parking spot is due to expire and, after expiration of a grace period after the rental time has completed, provide notification to a towing company regarding the vehicle that is parked in the parking spot for longer than the allocated rental time. In various embodiments the query from the second user device is a natural language search. In various embodiments, the system may mark, in a database, the parking spot as available for rent responsive to GPS data received from the first user device indicating the first user device has departed the vicinity of the parking spot. In various embodiments, the parking descriptor comprises at least one of covered, guarded, road side, driveway, garage, handicap, compact, commercial, residential, or lighted. The system may perform the receiving, selecting, returning, and displaying in real-time or near real-time. In various embodiments, the street address data is received from at least one of the first user device or the first user account and comprises a plain text input. In various embodiments, receiving the street address data further comprises receiving location data from an onboard sensor of the first user device and determining the street address data based on the location data. The system may generate a one-to-one association of the location data and the parking spot.

In another exemplary embodiment, a system is disclosed for generating a precision geolocated parking spot. The system may include a processor and a tangible, non-transitory memory configured to communicate with the processor, the tangible, non-transitory memory having instructions stored thereon that, in response to execution by the processor, cause the processor to perform operations. The system may register a parking spot to a user account in response to a registration request from a first user device. The system may associate the parking spot with a parking descriptor. The system may receive a first location data from the first user device and may associate the first location data with the parking spot on a one-to-one basis and generate a precision geolocated parking spot.

In various embodiments, associating the parking spot with the parking descriptor may further comprise the system generating a spot identifier and associating the spot identifier with the parking spot and populating a spot identifier field of a parking spot properties interface. In various embodiments, receiving the first location data may further comprise receiving a plain text longitude input and a plain text latitude input from a precision geolocation interface of the first user device and storing the plain text longitude input and the plain text latitude input as the first location data or receiving the first location data from an onboard sensor of the user device in response to a pull command from the first user device. The system may populate a longitude field and a latitude field of the precision geolocation interface in response to receiving the first location data from the onboard sensor of the first user device. In various embodiments, the system may receive a second location data from onboard sensors of a second user device. The system may determine a distance from the precision geolocated parking spot and the second user device based on the second location data. The system may update a distance display of a details panel of a search results interface based on the distance determined.

The forgoing features and elements may be combined in various combinations without exclusivity, unless expressly indicated herein otherwise. These features and elements as well as the operation of the disclosed embodiments will become more apparent in light of the following description and accompanying drawings. The contents of this summary section are intended only as a simplified introduction to the disclosure and are not intended to be used to limit the scope of any claim.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates a parking system for matching users with parking spaces to drivers seeking parking spaces, in accordance with various embodiments;

FIG. 2 illustrates a navigation interface for an application to match users with parking spaces to drivers seeking parking spaces, in accordance with various embodiments;

FIG. 3 illustrates a search interface to search for parking spots based on a natural language search criteria, in accordance with various embodiments;

FIG. 4A illustrates a search results interface to identify available parking spots that match a natural language search criteria, in accordance with various embodiments;

FIG. 4B illustrates a search results interface to identify available parking spots, in accordance with various embodiments;

FIG. 4C illustrates a search results interface to identify available parking spots, in accordance with various embodiments;

FIG. 4D illustrates a parking spot properties interface, in accordance with various embodiments;

FIG. 5 illustrates a search interface to search for parking spots based on a selected criteria, in accordance with various embodiments;

FIG. 6 illustrates a search results interface to identify available parking spots that match search criteria, in accordance with various embodiments;

FIG. 7 illustrates a method for matching a parking spot to a driver, in accordance with various embodiments;

FIG. 8 illustrates a method for processing a natural language search for a parking spot, in accordance with various embodiments; and

FIGS. 9A through 9F illustrate a method for processing a natural language search for a parking spot, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Exemplary systems and methods disclosed herein match people with parking spots to people that need parking. Users with proprietary rights in parking spots can add their parking spots to a database of parking spots. Users can match to a parking spot based on various criteria using a computing device. The matching criteria can be user specified, or automatically provided by back-end systems. Users can select and rent parking spaces for limited periods of time, for example in connection with a mobile device application and related back-end systems.

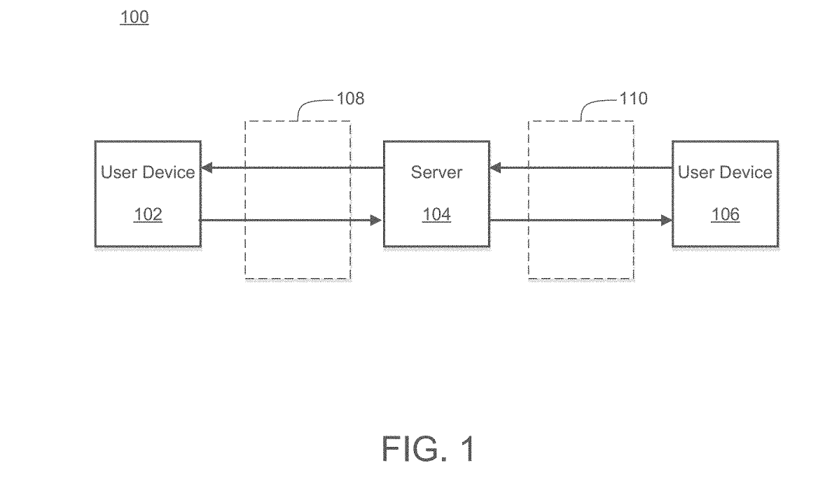

With reference now to FIG. 1, parking system 100 for matching parking spaces and drivers is illustrated, in accordance with various embodiments. Parking system 100 may include a user device 102 for use by a user having access to and/or control over a parking spot (for example, via ownership, rental of an associated property, and/or the like). User device 102 may be in communication with server 104 over network 108 to register and/or manage the status of the user's parking spot. Parking system 100 may also include user device 106 in communication with server 104 over network 110 to locate a suitable parking spot.

User device 102 and user device 106 may include computing devices suitable for electronic communication with server 104, which may act as an intermediary. In various embodiments, user device 102 and user device 106 may communicate directly and eliminate or reduce communication with server 104 in a direct peer-to-peer manner. User device 102 and user device 106 may thus be any suitable computing device (e.g., personal computing device/mobile communication device) which communicates via any suitable electronic network. User device 102 and user device 106 may comprise onboard sensors such as, for example, GPS, accelerometers, or other location service data receivers or systems configured for gathering and/or generating precision geolocation information (i.e. location data). User device 102 and user device 106 may also comprise a near-field communication (NFC) enabled device, such as a smartphone (e.g., iPhone, BlackBerry, Android, and/or the like), a smart-ring, and/or the like.

A web application or dedicated application may be associated with and/or used by any combination of user device 102, user device 106, and/or server 104. In this regard, a web application may comprise a variety of browsing software or browser applications, for example, Microsoft Internet Explorer, Mozilla Firefox, Google Chrome, Apple Safari, a native application, or any other suitable software packages available for communicating over a network 108, network 110, and/or other communication channels. Server 104 may also provide web services by running applications, for example, Apache web server software or the like. Exemplary applications operative on server 104 may, for example, include applications developed in the Go programming language or other suitable programming language. Moreover, in various exemplary embodiments it will be appreciated that references to a single server herein may be understood as references to a plurality of servers, cloud-based systems, virtual servers, and/or the like, for example in order to provide scalability and flexibility to a system.

Browser applications may comprise network-capable software installed within a computing unit or a system to conduct parking-related transactions and/or communications. These computing units or systems may take the form of a computer or processor, or a set of computers/processors, although other types of computing units or systems may be used, including laptops, notebooks, servers, hand-held computers, personal digital assistants, cellular phones, smart phones (e.g., iPhone®, BlackBerry®, Droid®, etc.) tablets such as iPads, wearable computing devices such as smart watches or smart glasses, in-vehicle computers such as computers installed in cars, trucks, motorcycles or other vehicles, or any suitable device capable of receiving data over network 108 and/or network 110.

As those skilled in the art will appreciate, a user device may include an operating system (e.g., Windows NT, 95/98/2000/CE/Mobile/Win7/Win8/Win10, OS2, UNIX, Linux, Solaris, iOS, Android, etc.) as well as various conventional support software and drivers typically associated with computers. A user device may implement security protocols such as Secure Sockets Layer (SSL) and Transport Layer Security (TLS) for communication over a network. Any device used in parking system 100 may also implement one or more application layer protocols, including, for example, HTTP, HTTPS, FTP, XMPP, and/or SFTP.

Network 108 and network 110 may be the same or similar, or may use any available networking technology. For example, a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device, online communications, satellite communications, off-line communications, wireless communications, transponder communications, local area network (LAN), wide area network (WAN), virtual private network (VPN), networked or linked devices and/or any suitable communication device. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers.

Communications over networks described herein may thus be encrypted. Encryption may be used for communication over network 108 and/or network 110. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

In various embodiments, server 104 may be configured to provide parking spot registration, searching, and matching features. User device 102 may send and receive messages over network 108 with server 104 to facilitate registration of parking spots. The messages may include images of parking spots, images of property maps, image metadata, GPS data, location data, and other data captured by user device 102. The messages may also include user-specified data such as descriptors of the parking spot, text, pricing, availability, parking spot dimensions, distance to popular destinations, and/or selectable features associated with the parking spot. Parking spot descriptors may be selected using check boxes, radio buttons, plain text, or other suitable user interface components. Parking spot descriptors may include covered, guarded, road side, driveway, garage, handicap, compact, commercial, residential, lighted, motorcycle, or other suitable parking spot descriptors, for example. Parking spot descriptors may be used to match with search.

Parking spot descriptors may also include availability. Availability may be a toggled feature with user device 102 configured to flag a spot as available or unavailable as the user of user device 102 vacates or occupies the spot. User device 102 may set an availability flag based on GPS data of user device 102, for example, in response to user device 102 moving across a geofence located about the parking spot. User device 102 may also enable a user to manually select between vacant and occupied status. User device 102 may also enable a user to vary the availability of a parking spot based on a time schedule.

Parking spots and/or users associated with parking spots may accumulate reviews as other users use the parking spot and/or interact with the parking spot owner. Reviews may assess the accuracy of parking spot descriptors associated with the parking spot, ease of use, and/or hospitality of the parking spot owner, for example. In operation of parking system 100, parking spots and/or parking spot owners may be put on probation and/or disqualified from matching with drivers in response to the average review dropping below a predetermined threshold. Moreover, users of parking system 100 may filter parking spots by the reviews. For example, users may filter searches so that the search only returns parking spots associated with parking spot owner ratings above a threshold rating. The rating system may be a star rating system, numerical rating system, letter rating system, or any other suitable rating system. Navigation interface 200 and other interfaces described herein may include content display 204. Content display 204 may be suitable for showing text, images, video, other content, and/or advertisements.

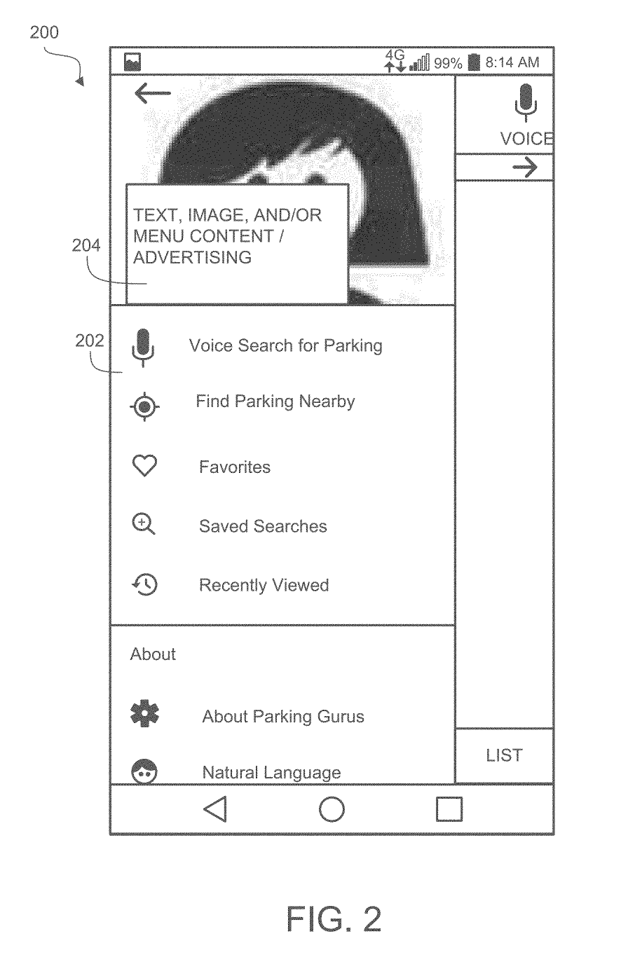

Referring now to FIG. 2, an example of a navigation interface 200 for a peer-to-peer parking application is shown for display on user device 106, in accordance with various embodiments. Navigation interface 200 may include search options 202. Search options 202 may be a list of available search options such as, for example, voice search, nearby parking, favorites, saved searches, text search, and selectable criteria search. The peer-to-peer parking application may load a corresponding search interface in response to selection of a search option 202 on navigation interface 200.

The voice search option may link to a voice search interface. User device 106 may detect the audio search request, for example using a microphone on user device 106. User device 106 then parses the audio to identify words and convert the audio to text-based search. Voice search options are discussed hereinbelow in further detail with reference to method 800. Other search options may include a text-based search where a user may enter text directly using a keyboard of user device 106. A field-based search may also be used to search for parking spots. A field-based search may have predetermined fields with enterable and/or selectable search criteria.

Each of the above searches may comprise various search terms identifiable as search criteria. The search criteria may be used to query a database of parking spots and select available parking spots matching the search criteria. The database may be, for example, a relational database with fields for each criteria searchable using SQL. The database may also be a document-based database, a non-relational database, a flat file, a big data storage system,or any other suitable data storage system.

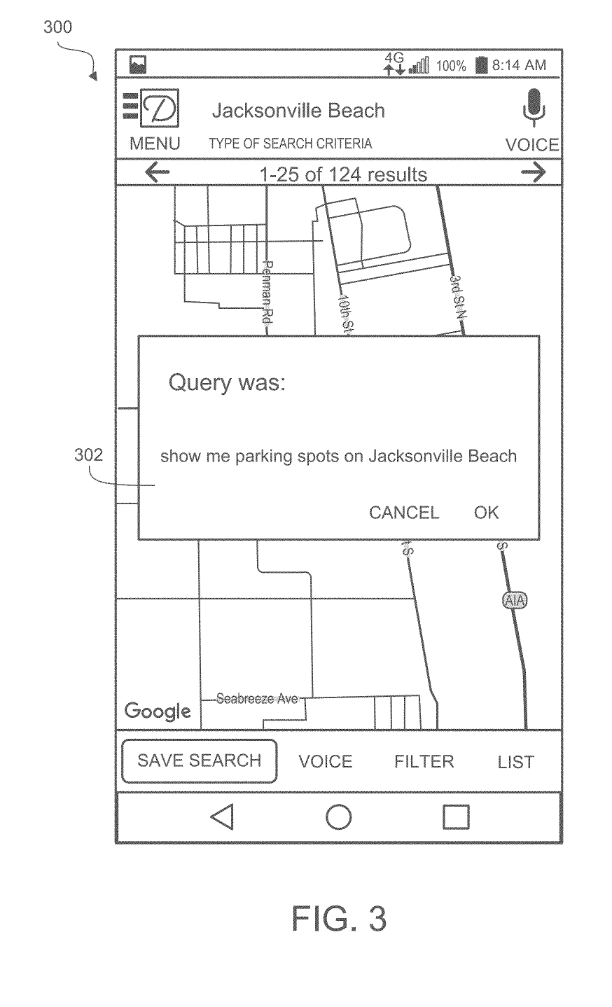

Referring now to FIG. 3, a voice search interface 300 is shown according to various embodiments. Voice search interface 300 may include search box 302. Search box 302 may display text corresponding to the detected user vocal commands. In the example illustrated in FIG. 3, search box 302 illustrates parking system 100 having detected the user stating “show me parking spots on Jacksonville Beach.” The user may select OK to approve the detected text and submit the search. The user may also select CANCEL to cancel the query and/or re-enter verbal commands.

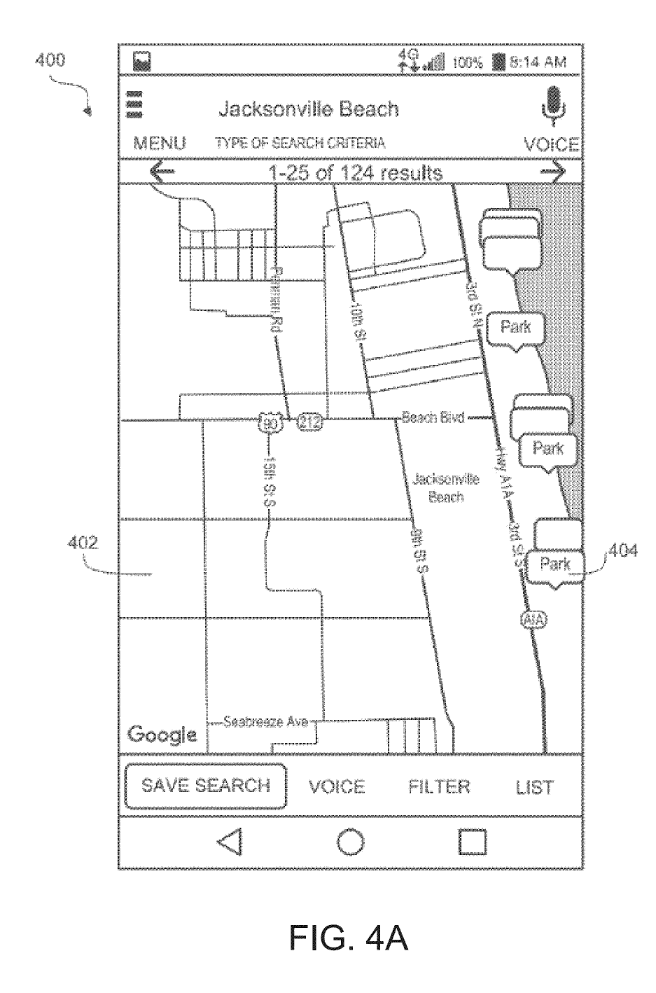

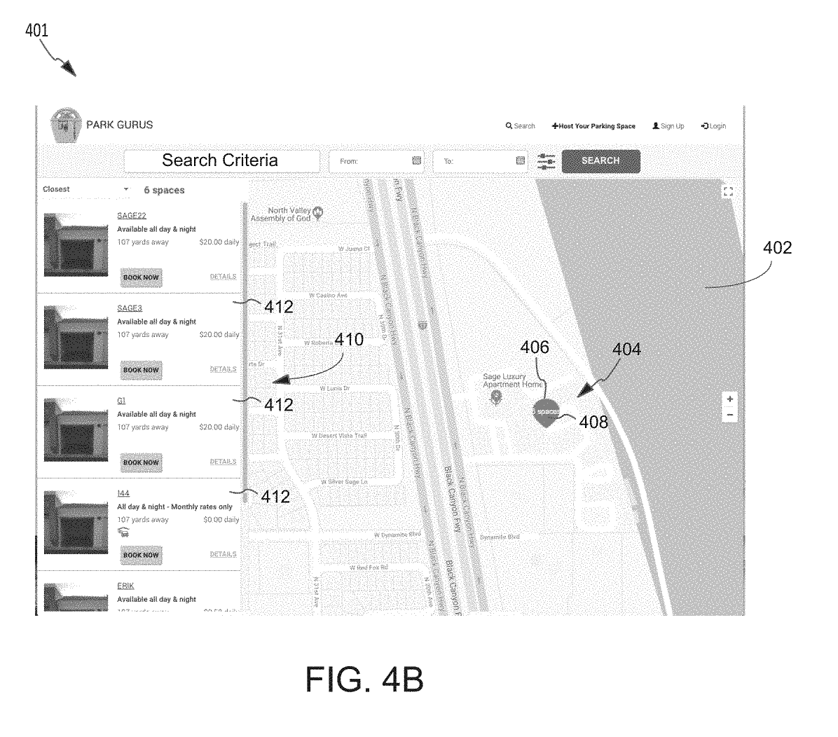

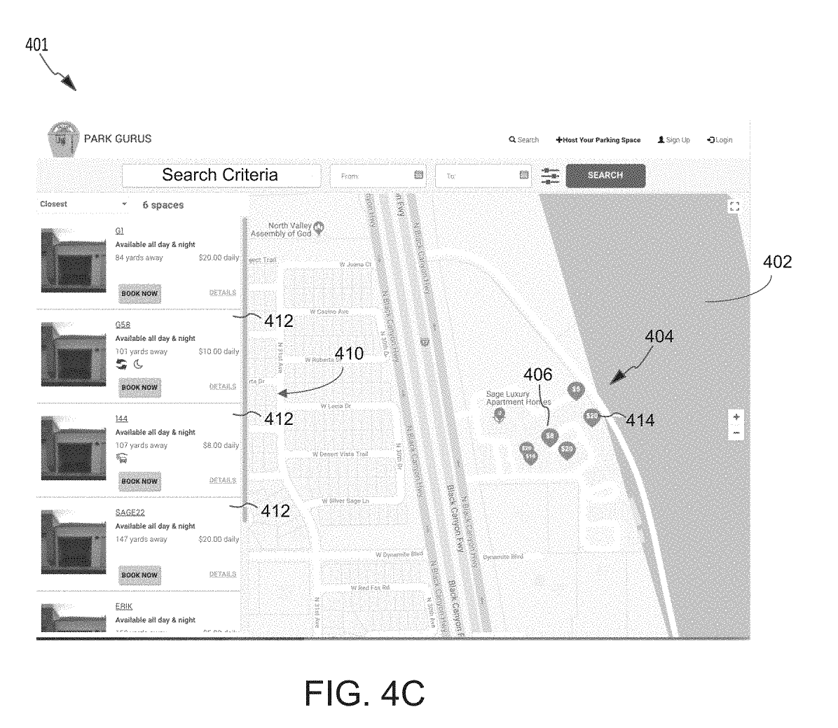

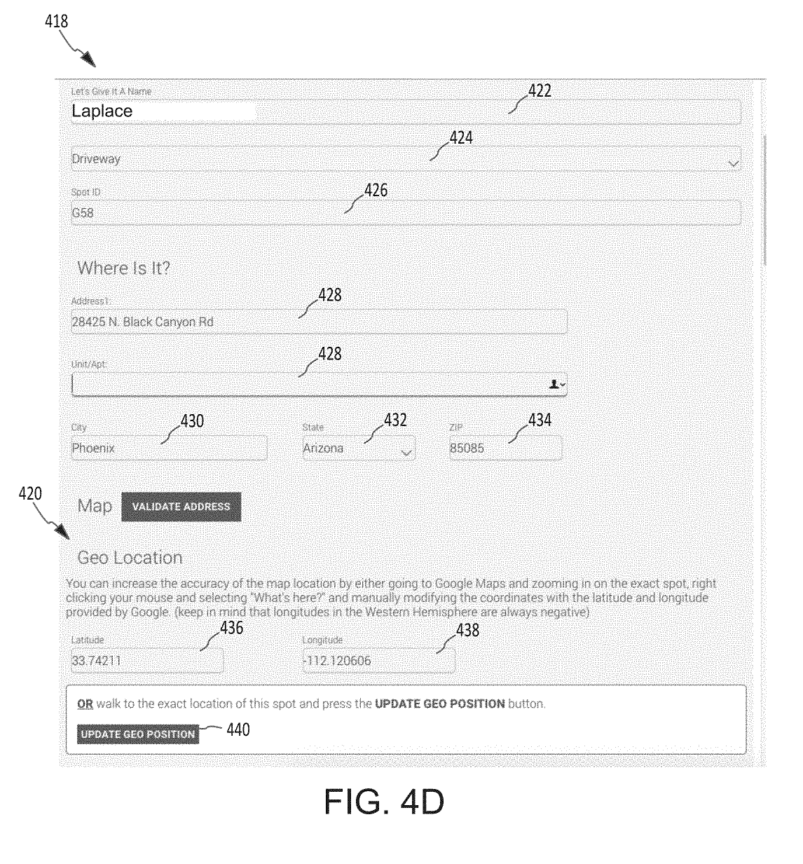

With reference now to FIG. 4A, a search results interface 400 is shown according to various embodiments. Search results interface 400 may include a map 402 with parking icons 404. Parking icons 404 may be located on the map at a position corresponding to the geographic location of the associated parking spot. The location of the parking spot may be captured, for example, using GPS data from user device 102 or by entering an address, for example. Each parking icon 404 may be representative of a single parking spot (i.e. a one-to-one association between icon and parking spot) or of multiple parking spots within a predetermined distance of one another (i.e. a one-to-many association between icon and parking spots).

With additional reference to FIG. 4B a search results interface 401 is shown according to various embodiments. Search results interface 401 may be similar to search results interface 400. Parking icon 404 is illustrated in a one-to-many association, for example, five parking spots available in a single parking area may be identified by a parking icon 404 displayed on map 402 which may indicate the number of aggregated spaces by displaying within icon boundary 406 an aggregation message 408 such as ‘5 spaces’. Each of the aggregated spaces is associated with the single area (e.g., a reference geolocation, street address, and/or the like) such as, for example, one of a point of interest, a parking complex, or an apartment complex. A details frame 410 presents a plurality of detail panels 412. Each of the detail panels 412 is associated on a one-to-one basis with each of the parking spaces and describes and illustrates detail elements of the parking space such as, for example, price and reviews,of the parking spot descriptors. In various embodiments, details frame 410 may be populated in response to selecting the parking icon 404.

With additional reference to FIG. 4C, parking icons 404 are illustrated in a one-to-one association where each of parking icons 404 are representative of a precision geolocated parking spot. In contrast to the aggregated spaces, each of the precision geolocated parking spots are associated on a one-to-one basis with a unique geospatial coordinate reference such as, for example, a latitude and a longitude. Parking icons 404 may display a precision location identifier 414 such as, for example, a price message, a symbolic reference, a contrasting color, a contrasting shape (e.g. an alteration of icon boundary 406), and/or the like which may tend to differentiate aggregated spaces from precision geolocated spots. Map 402 may comprise a property map received by parking system 100 from a user device and search results interface 410 may display parking icons 404 representative of precision geolocated parking spots relative to the property map. In various embodiments, each of the details panels 412 associated with each of the precision geolocated parking spots may display a distance to the precision geolocated parking spot as measured between the precision geolocated parking spot and a user device such as, for example, user device 102 and/or user device 106. Parking system 100 may determine the distance between the user device and the precision geolocated parking space in real-time or near real-time based on location data from onboard sensors. Parking system 100 may update the details panels 412 distance display in real time based on the distance determination. In various embodiments, any of parking icons 404 and/or details panels 412 may be selectable to purchase the spot for a selectable duration. Parking icons 404 and/or details panels 412 may also be selectable to access further information about the corresponding parking spot such as an image, text description, and associated parking spot descriptors.

Search results interface 400 may include options for saving a search, submitting a new search, filtering the search results based on parking spot descriptors, and/or displaying the search in a list format. Search results interface 400 may also include arrows selectable to cycle through the search results without selecting a parking icon 404 directly. The user may select the desired parking spot by finding the parking icon associated with the desired parking spot and selecting a “park” button to reserve the parking spot. The owner of the parking spot may be notified of the match with a driver. The owner of the parking spot may have the option to accept or decline the match. The parking spot may also be automatically reserved without approval by the owner of the parking spot.

Referring briefly to FIGS. 3 through 4C, the parking icons 404 displayed on search results interface 400 may include the parking spots responsive to the search query entered in search box 302. The parking spots may be identified by converting the text search into a database query to identify parking spots responsive to the query. The parking spots responsive to the query may be further filtered based on search criteria to present a list of parking spot icons corresponding to parking spots responsive to the search query.

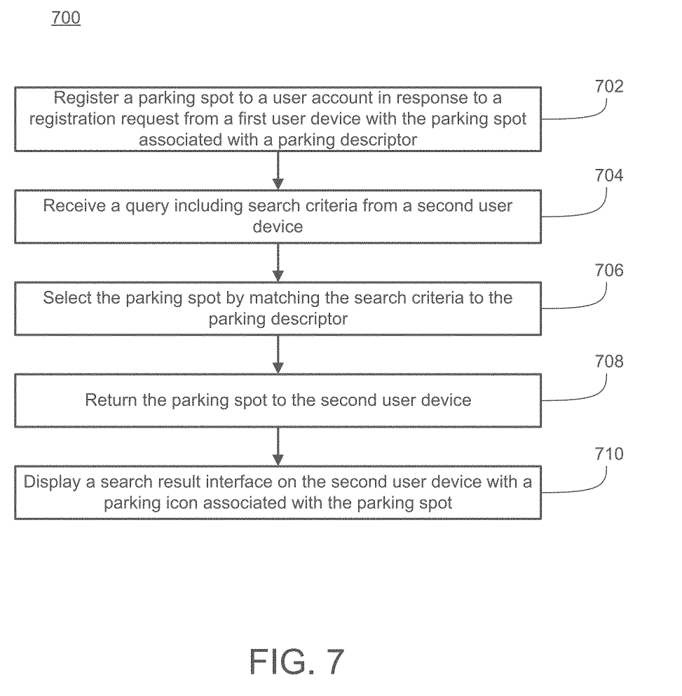

In various embodiments and with reference now to FIG. 4D, a parking spot properties interface 418 comprising a precision geolocation interface 420 is illustrated. Parking spot properties interface 418 may comprise a plurality of forms, frames, fields, buttons, menus, and/or the like enabling parking system 100 to receive data such as parking spot descriptors including location data from a user device such as user device 102 and user device 106. Parking spot properties interface 418 may include general descriptor elements such as a name field 422, a spot type field 424, and a spot identifier field 426. In various embodiments, spot type field 424 may be a drop down style input comprising an array of spot types such as, for example, covered, guarded, road side, driveway, handicap, compact, trailer, RV, commercial, residential, gravel, garage, reserved, carpool, and/or the like. With brief additional reference to FIG. 7, parking system 100 may generate a spot identifier in response to receiving a registration request from a user device such as user device 102 and may display the spot identifier in spot identifier field 426.

Parking spot properties interface 418 comprises general location descriptor elements such as street address fields 428, city field 430, state field 432, and zip code field 434 describing street address data. Street address fields 428, city field 430, state field 432, and zip code field 432 may be configured to receive plain text inputs from a user device as street address data. In another example, state field 432 may be a drop down style input comprising an array of states. Parking system 100 may associate the street address data with a parking spot. In various embodiments, parking system 100 may generate a one-to-many association of the street address data to a plurality of parking spots in response to receiving the street address data. In various embodiments, parking system 100 may receive location data from a user device such as user device 102 and determine the street address data based on the location data. Parking system 100 may populate any of the location descriptor elements and in response to determining the street address data.

In various embodiments, parking system 100 may receive location data in response to an input from precision geolocation interface 420. For example, parking system 100 may receive a plain text latitude input from latitude field 436 and may receive a plain text longitude input from longitude field 438. In another example, parking system 100 may receive location data from onboard sensors of user device 102 in response to a pull command from user device 102 which may be generated by a user selecting an update geo position button 440. In various embodiments, parking system 100 may populate latitude field 436 and longitude field 438 with the location data from the onboard sensors in response to the pull command. In response to receiving the location data, parking system 100 may generate a one-to-one association between a parking spot and the location data thereby generating a precision geolocated parking spot.

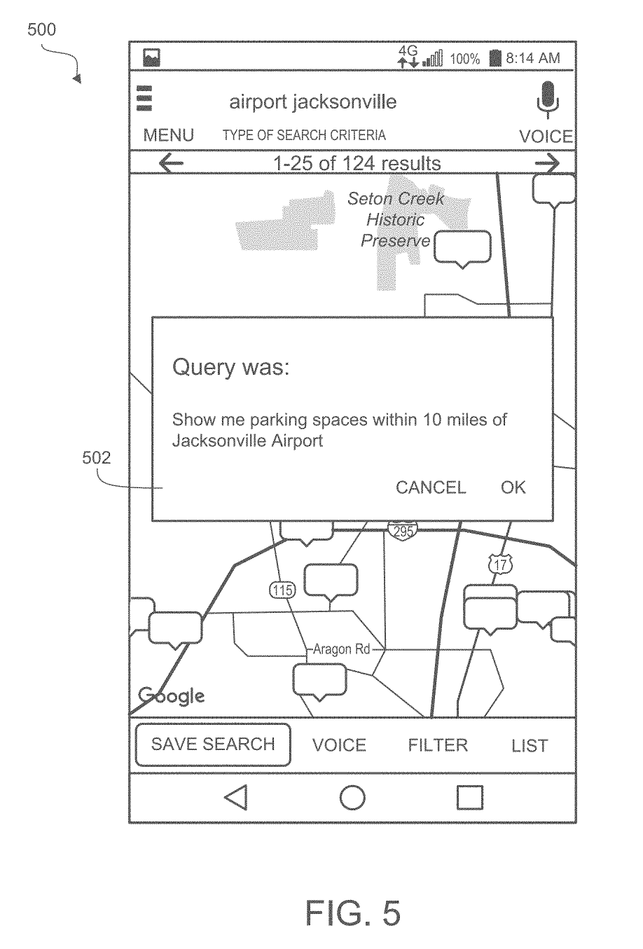

Referring now to FIG. 5, a search interface 500 is shown according to various embodiments. Search interface 500 may be similar to voice search interface 300, which was described herein with reference to FIG. 3. Search interface 500 may include a search box 502 suitable for entering a query. As shown in the example illustrated in FIG. 5, the search query entered was a natural language search for the phrase “Show me parking spaces within 10 miles of Jacksonville Airport.” The phrase may be parsed to identify search criteria suitable for selecting parking spots responsive to the criteria from a database and/or filtering the parking spots.

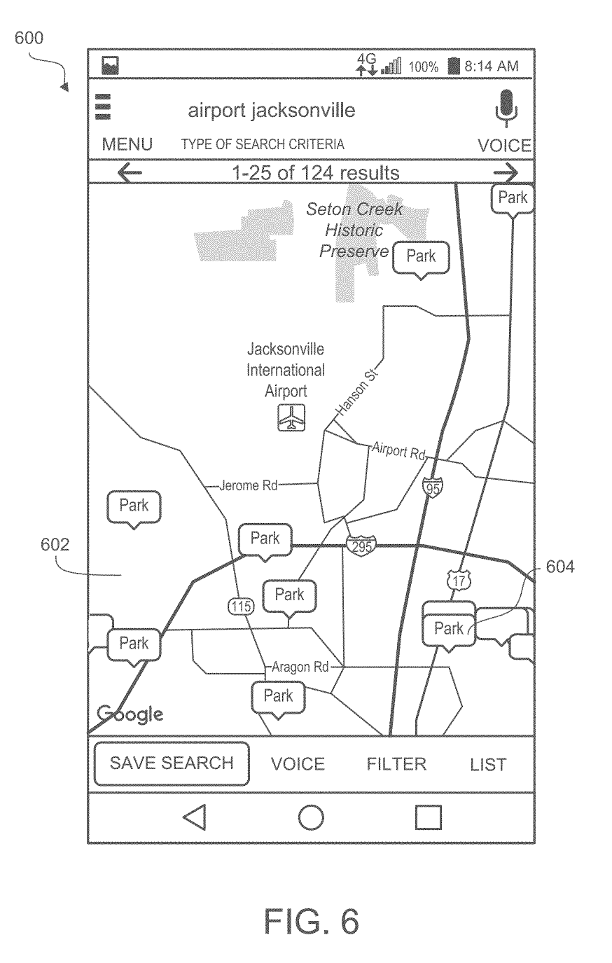

With reference now to FIG. 6 and in accordance with various embodiments, FIG. 6 illustrates a search results interface 600 displaying search results responsive to the query in search box 502. Search results interface 600 may include a map 602 similar to map 402. Search results interface 600 may also include parking icons 604 similar to parking icons 404. Parking icons 604 may be associated with parking spaces responsive to the search query of search box 502. Parking icons 604 may thus be selectable to reserve the parking space associated with parking icons 604.

With reference to FIG. 7, a process 700 for matching a parking spot to a driver is shown, in accordance with various embodiments. Parking system 100 may register a parking spot to a user account in response to a registration request received from a first user device 102 (step 702). The parking spot may be associated with various parking descriptors provided by the first user device 102 along with the registration request. The descriptors may be modified by the user as the parking spot changes by a user logging in to provide updated parking descriptors.

Parking system 100 may receive a query including search criteria from a second user device 106 (step 704). The search criteria may be a list of desired parking descriptors in a parking spot. The search criteria may include a location and a distance from the location, for example. Parking system 100 may select one or more potential parking spots by matching the search criteria to the parking descriptor (step 706). The system may use a SQL statement using the search criteria as terms in the SQL statement to select parking spots matching the search criteria from a database. Although SQL is used as an exemplary query language, other suitable query languages and/or systems may be used, for example for data storage systems other than relational databases.

Parking system 100 may return identification of one or more matching parking spots to the second user device 106 (step 708). The parking spots may be returned in search results sent to the second user device 106. The parking spots may include a geographic location corresponding to a location on a map for display to the user to convey the location of the parking spot to the user. The system may display a search result interface on second user device 106 with a parking icon associated with the parking spot (step 710). Moreover, it will be appreciated that when no suitable matching parking spot is located, a corresponding response may be sent to second user device 106.

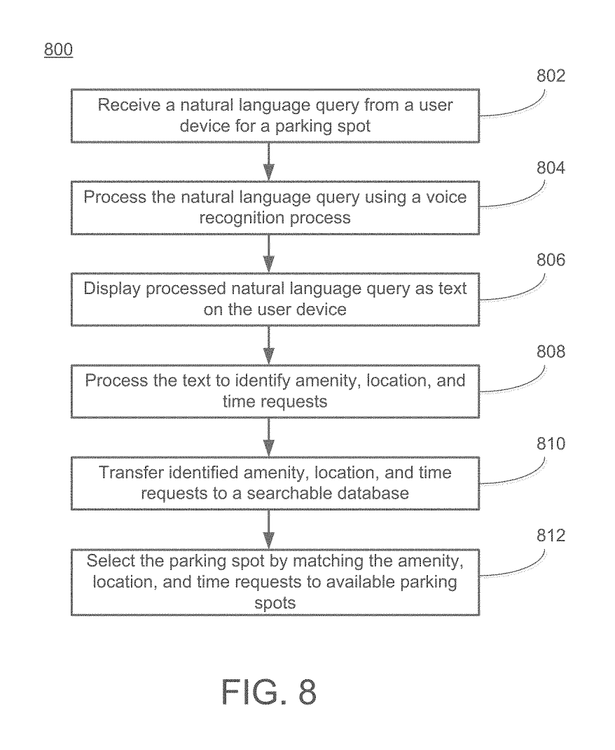

In various exemplary embodiments, to facilitate ease of use, parking system 100 may be configured to receive, parse, and process commands received via voice. With reference now to FIG. 8, a method 800 for processing a natural language search for a parking spot is shown, in accordance with various embodiments. Parking system 100 may receive a natural language query from a user device 106 (step 802). Natural language query may be, for example, a voice search. The voice search may link to a voice search interface. User device 106 may detect the natural language query, for example using a microphone on user device 106.

The natural language query may be processed by a voice recognition process (step 804). A suitable voice recognition process may include Apple voice for IOS and Google voice for Android, or another voice recognition process software. The natural language query may be returned and displayed on user device 106 as proposed text for user approval (step 806). For example, momentarily returning to FIG. 3, search box 302 of user device 106 may display text corresponding to the detected user vocal commands. The user may select OK to approve the detected text and submit the search. The user may also select CANCEL to cancel the query and/or re-enter verbal commands.

The text may be processed to identify amenity, location, time, or other requests contained therein (step 808). Additionally, the text may be cleaned to remove unnecessary or redundant language. As an example, a converted natural language query to text statement may state, “I would like a parking space”. In step 808, this language may be removed. Step 808 may also include normalizing the text. For example, a converted natural language to text statement may state, “12 noon”. This and other similar texts may be normalized, for example to “12:00 PM”, to further increase efficiency of step 808.

With further reference to step 808, the text may be filtered to locate an amenity request. For example, the text may be scanned for amenity requests such as valet service, security service, shuttling service, handicap access, and/or other amenities. Step 808 may include filtering the text for amenity requests before other requests to limit the number of search results. Located amenity requests may be converted to a SQL statement or other suitable query languages and/or system.

Step 808 may further include filtering the text to identify a geographic location request. Geographic location request identifiers may include a location of the user, complete address, point of interest, city, street corner, or other geographic location. Points of interest may include apartment complexes, universities, stores, restaurants, sporting venues, buildings, or other locations. Located location requests may be processed by a location database, for example, a Google or Microsoft location database to determine a latitude and longitude of the geographic location. The latitude and longitude may be added to the SQL statement or other suitable query languages and/or system. If no geographic location is found, user device 106 may return an error message, prompting the user to re-enter geographic information into user device 106.

Step 808 may further include filtering the text to identify a time request. For example, the text may be filtered to identify day references (e.g. today, tomorrow, and so forth), week references (e.g. next week or week of July 10^{th}), month references (e.g. month of August), date references (e.g. March 10^{th}), and/or date and time references (e.g. March 10^{th} from 3:00 PM to 6:00 PM). Located time requests may be added to the SQL statement or other suitable query languages and/or system. If no time request is found, user device 106 may return an error message, prompting the user to re-enter time information into user device 106. Parking system 100 may apply the SQL query statement, including any amenity, geographic location, and/or time requests, to a searchable database (step 810). Parking system 100 may select a parking spot by matching the amenity, location, and time requests to available parking spots (step 812). Method 800 may aid a user in finding a parking spot with desired amenities, locations, and/or times without the need to manually enter the information into a device. This results in a safer and more time efficient parking search for the user.

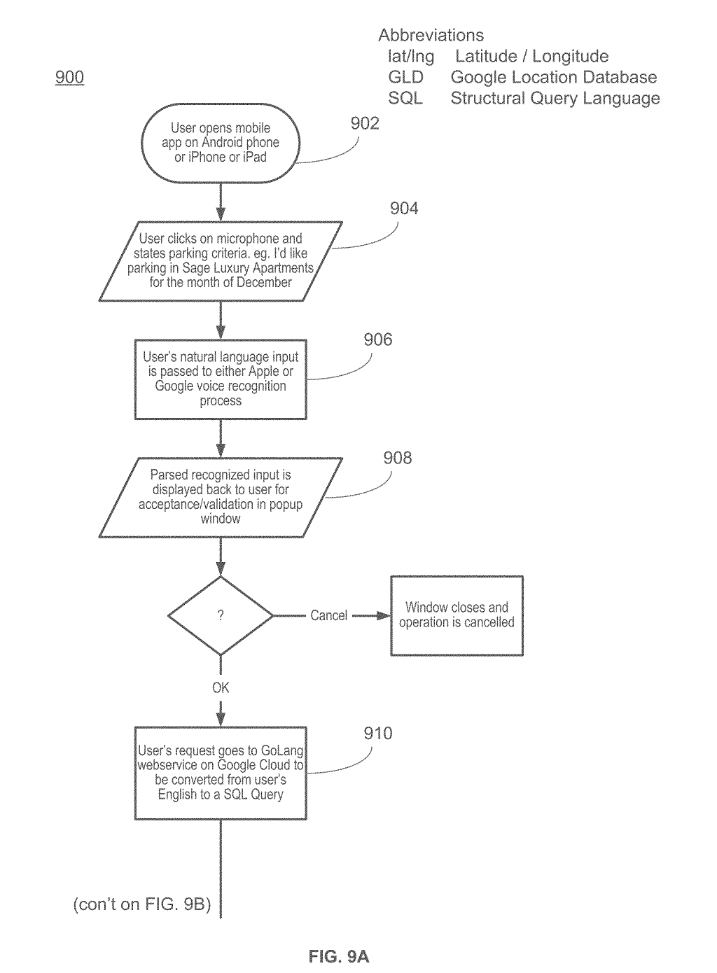

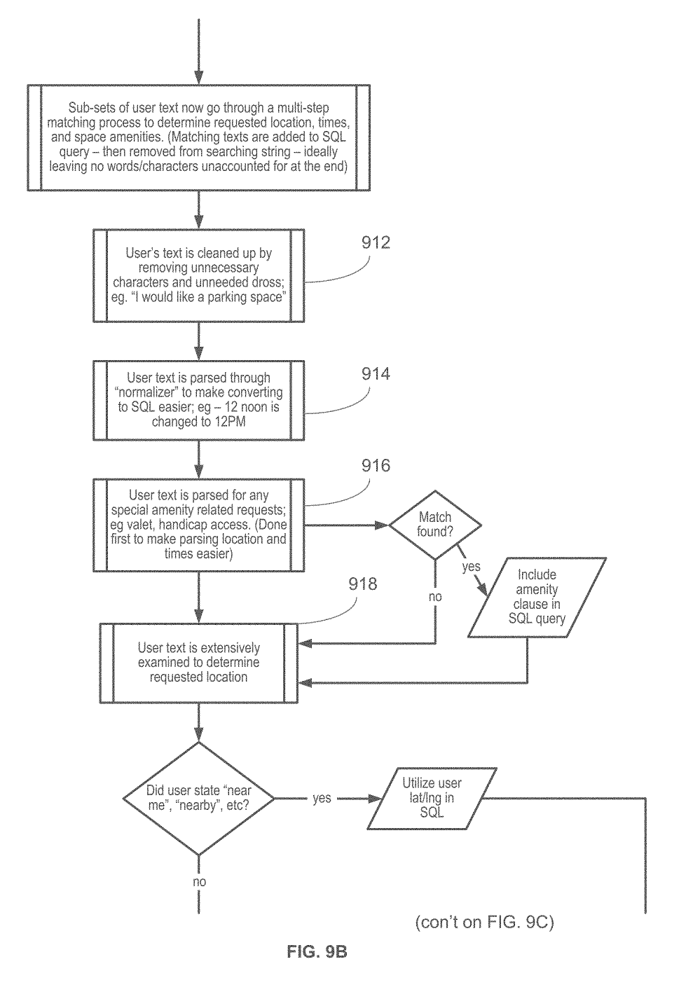

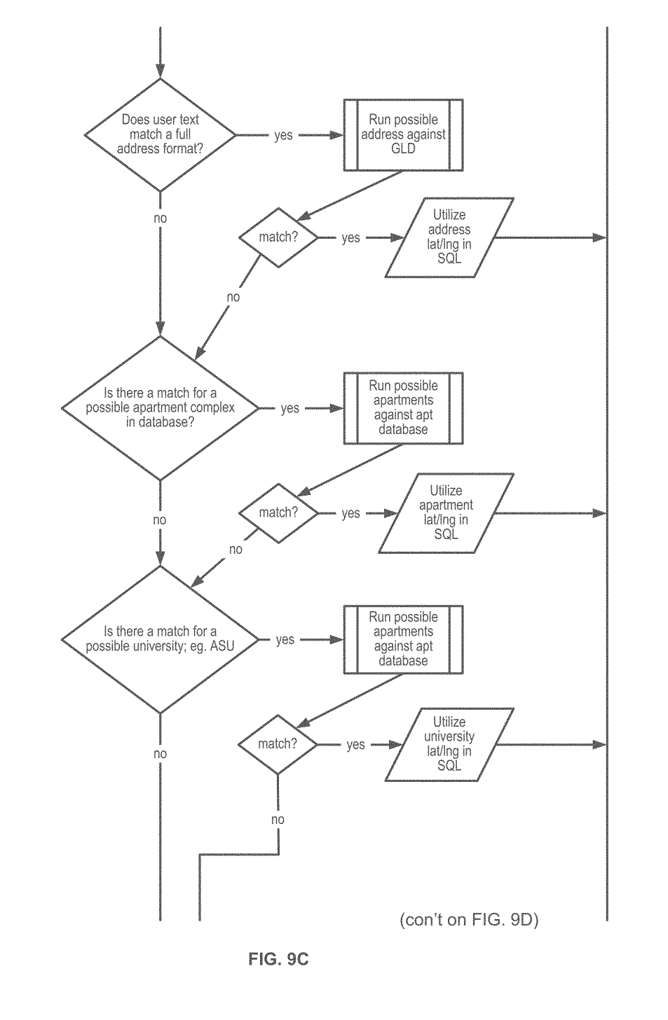

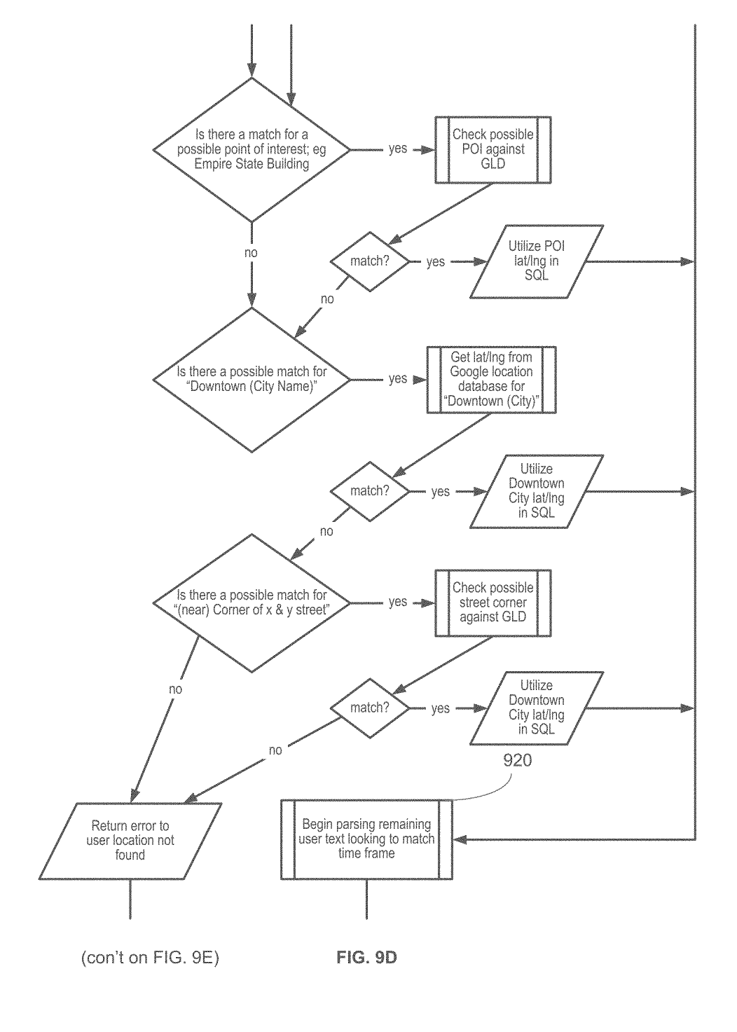

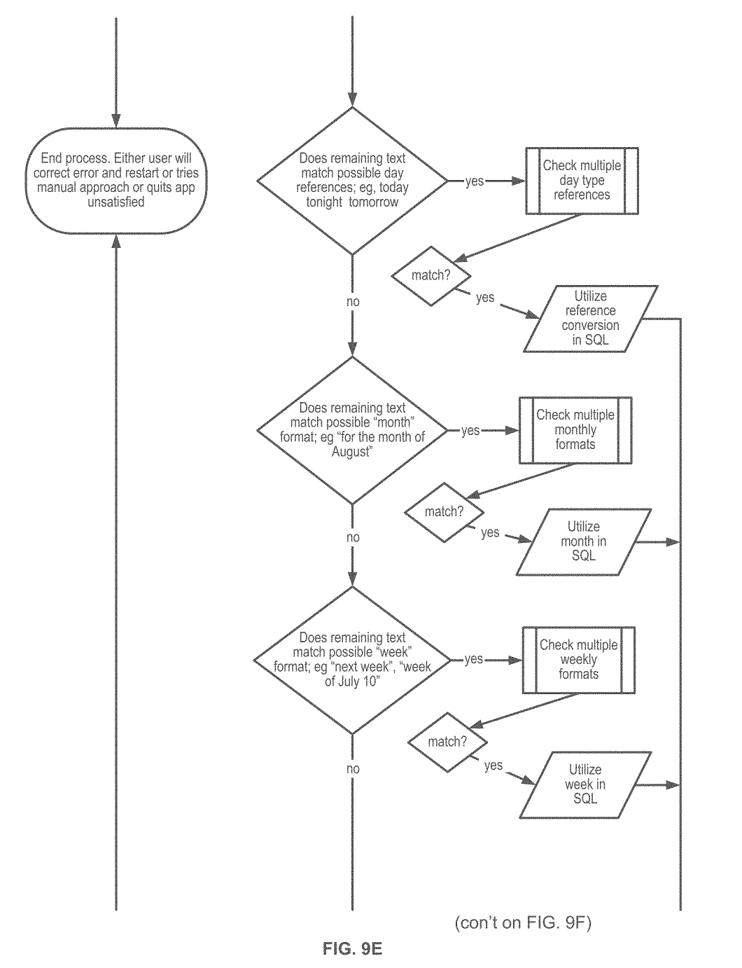

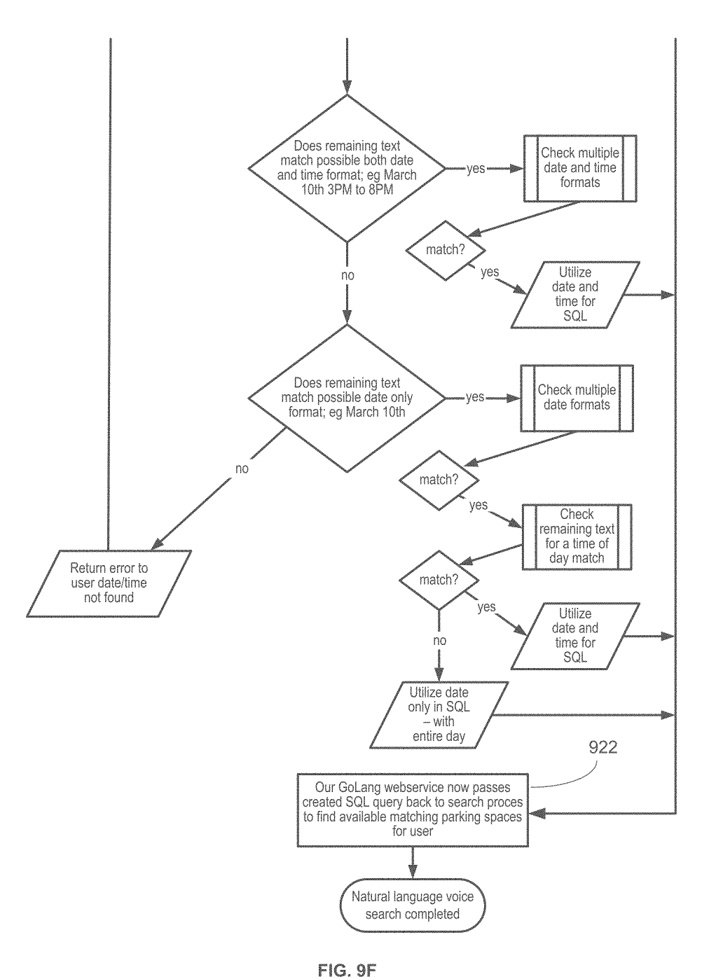

In various exemplary embodiments, to facilitate ease of use, parking system 100 may be configured to receive, parse, and process commands received via voice. With reference now to FIGS. 9A through 9F, method 900 for processing a natural language search for a parking spot is shown, in accordance with various embodiments. Parking system 100 may include an application to be opened by a user on second user device 106 (step 902). Second user device 106 may be an Android phone, iPhone, iPad, or any other device disclosed herein in reference to second user device 106. Parking system 100 may receive a natural language query for parking criteria from a user clicking on a microphone icon in the mobile application (step 904). For example, the natural language query may state, “I'd like parking in Sage Luxury Apartments for the month of December.”

A user's natural language query may be passed to a voice recognition process (step 906). A suitable voice recognition process may include Apple voice for IOS and Google voice for Android, or other suitable voice recognition process software. The parsed natural language query may then be displayed back to the user for acceptance or validation in a popup window (step 908). For example, momentarily returning to FIG. 3, search box 302 of user device 106 may display text corresponding to the detected user vocal commands. The user may select OK to approve the detected text and submit the search. The user may also select CANCEL to cancel the query and/or re-enter verbal commands.

User's request may then be transferred to a webservice on a cloud-based system to be converted from a natural language query to an SQL statement or other suitable query languages and/or system (step 910). Step 910 may include transferring sub-sets of user texts through a multi-step matching process to determine requested location, time, and space amenities. Matching texts may be added to the SQL statement or other suitable query languages and/or system and removed from a searching string, thereby leaving no words/characters left unaccounted for.

User's text may be cleaned by removing unnecessary characters and unneeded dross (step 912). For example, user's text statement may state, “I would like a parking space”. In step 912, this language may be removed. User's text may also be normalized (step 914). For example, a user's text may state, “12 noon”. This and other similar texts may be normalized to “12:00 PM” to further increase efficiency.

Once cleaned and normalized, a user's text may be parsed for any special amenity related requests (step 916). Similar to method 800, the text may be scanned for amenity requests such as valet service, security service, shuttling service, handicap access, and/or other amenities. Step 916 may include filtering the text for amenity requests before other requests to limit the number of search results. Located amenity requests may be used in a SQL statement or other suitable query languages and/or system.

A user's text may be parsed to determine a requested location (step 918). For example, a user's text may be parsed to determine whether the user stated “near me” or “nearby” for example. If so, the user's latitude and longitude may be used in a SQL statement or other suitable query languages and/or system. If no “near me” or “nearby” language is found, the user's text may be parsed to determine whether the text stated a full address. If so, the full address may be transferred to a location database, for example, a Google or Microsoft location database to determine a latitude and longitude of the full address. The latitude and longitude may be used in a SQL statement or other suitable query languages and/or system. If no full address is found, the user's text may be parsed to determine whether the user stated an apartment complex. If so, the apartment complex may be transferred to a location database, for example, a Google or Microsoft location database to determine a latitude and longitude of the apartment complex. The latitude and longitude may be used in a SQL statement or other suitable query languages and/or system. If no apartment complex is found, the user's text may be parsed to determine whether the user stated a university. If so, the university may be transferred to a location database, for example, a Google or Microsoft location database to determine a latitude and longitude of the university. The latitude and longitude may be used in a SQL statement or other suitable query languages and/or system. If no university is found, the user's text may be parsed to determine whether the user stated a point of interest. If so, the point of interest may be transferred to a location database, for example, a Google or Microsoft location database to determine a latitude and longitude of the point of interest. The latitude and longitude may be used in a SQL statement or other suitable query languages and/or system. If no point of interest is found, the user's text may be parsed to determine whether the user stated a city part. If so, the city part may be transferred to a location database, for example, a Google or Microsoft location database to determine a latitude and longitude of the city part. The latitude and longitude may be used in a SQL statement or other suitable query languages and/or system. If no city part is found, the user's text may be parsed to determine whether the user stated a street corner. If so, the street corner may be transferred to a location database, for example, a Google or Microsoft location database to determine a latitude and longitude of the street corner. The latitude and longitude may be used in a SQL statement or other suitable query languages and/or system. If no location is found, user device 106 may return an error message stating a user location is not found. Step 918 is not limited in this regard. For example, other locations may be included and/or the order of parsing may be rearranged in step 918.

A user's text may be parsed to determine a requested timeframe (step 920). For example, a user's text may be parsed to determine whether the user stated a day reference today, tomorrow, and so forth). If so, multiple day type references may be checked to determine a match and the day used in a SQL statement or other suitable query languages and/or system. If no day reference is found, the user's text may be parsed to determine a month format (e.g., month of August). If so, multiple monthly formats may be checked to determine a match and the month used in a SQL statement or other suitable query languages and/or system. If no month format is found, the user's text may be parsed to determine a week format (e.g., next week or week of July 10^{th}). If so, multiple weekly formats may be checked to determine a match and the week used in a SQL statement or other suitable query languages and/or system. If no week format is found, the user's text may be parsed to determine a date and time format (e.g., March 10^{th} from 3:00 PM to 6:00 PM). If so, multiple date and time formats may be checked to determine a match and the date and time used in a SQL statement or other suitable query languages and/or system. If no date and time format is found, the user's text may be parsed to determine a date only format (e.g., March 10^{th}). If so, multiple date formats may be checked and the remaining text parsed to find a time. If a time format is found, the date and time format may be used in a SQL statement or other suitable query languages and/or system. If no time format is found, the entire date may be used in a SQL statement or other suitable query languages and/or system. If no location is found, user device 106 may return an error message stating a timeframe is not found. Step 920 is not limited in this regard. For example, other timeframe formats may be included and/or the order of parsing may be rearranged in step 920. The webservice may pass the created SQL statement to a search process to find available matching parking spaces for a user, thereby completing the natural language search (step 922).

Parking system 100 matches users with parking spots to users searching for parking spots as described above. Parking system 100 acts as a peer-to-peer service in that regard by pairing suitable users. Additionally, parking system 100 may facilitate the transfer of funds from a user purchasing a parking spot to a user renting out a parking spot. For example, parking system 100 may be configured to receive funds from a user purchasing a parking spot, and thereafter transfer a portion of those funds to a user renting out a parking spot. Parking system 100 may also facilitate communication between matched users. Parking spots may be verified in parking system 100, for example by sending an inspector to physically inspect the parking spot and verify accuracy of parking spot descriptors. In parking system 100, verified parking spots may be sorted, distinguished, flagged, or otherwise provided elevated visibility, prominence in search results, and/or the like.

In some embodiments, parking system 100 is configured to bill and/or penalize a user of second user device 106 if the user remains in a parking spot for longer than the allotted time. For example, a surcharge may be applied to the user of second user device 106. Moreover, parking system 100 may be configured to notify a towing service if the user of second user device 106 fails to vacate a parking spot, for example after a grace period after the official rental period has expired.

In various exemplary embodiments, parking system 100 is configured to allow a parking space to be rented for selectable lengths of time, for example a number of minutes, a number of hours, a number of days, a number of weeks, and/or the like. Additionally, parking system 100 may be configured to allow a parking space to be rented starting at a specific time and/or ending at a specific time.

Via parking system 100, payment for a parking space rental may be accomplished via any suitable method. For example, a user of first user device 102 having a parking space for rent may provide a bank account, bitcoin address, PayPal account, Venmo account, or other suitable medium for receiving payments. Correspondingly, a user of second user device 106 desiring to rent a parking space may provide a bank account, credit card, bitcoin address, PayPal account, Venmo account, or any other suitable payment mechanism for tendering compensation in exchange for temporary use of the parking spot. Payments may be accomplished via use of server 104; alternatively, payments may be accomplished directly between the user of first user device 102 and the user of second user device 106. Individuals providing parking spaces for rent may receive a fraction of the list price for a particular parking spot; for example, a user of second user device 106 may rent a particular parking spot at a list price of $10 for three hours, and the user of first user device 102 may receive the rental price less a transaction fee collected, for example, by an operator of server 104. Payments to providers of parking spaces may be made each time the space is rented; alternatively, payments to providers of parking spaces may be aggregated and made at intervals, for example bi-weekly, monthly, or the like. Payment amounts may be determined based on the length of time the space is occupied, the proximity of the space to a point of interest, a size of a parking space, a demand for parking in a particular area, and/or a combination of these and other factors.

As parking spaces become marked as available in parking system 100, parking system 100 may provide active notifications and/or messages to a user of second user device 106, for example based on proximity of the user of second user device 106 to the location of a newly-available parking spot.

Systems, methods and computer program products are provided. In the detailed description herein, references to “various embodiments”, “one embodiment”. “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant arts) how to implement the disclosure in alternative embodiments.

As used herein, “satisfy,” “meet,” “match,” “associated with,” “identified with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a parking spot and (ii) a user owning the parking spot. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via a text-based communication channel.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, a user computer may include an operating system as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, wireless IEEE 802.11 wireless chip, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in a hard disk drive. These computer program products provide software to a computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs) may be utilized. Implementation of the hardware state machine so as to perform the functions described herein will be apparent to persons skilled in the relevant art(s).

In various embodiments, components, modules, and/or engines of parking system 100 may be implemented as native applications. Native applications may be deployed in the context of a mobile operating system, including for example, a Windows mobile, Android, iOS, a Blackberry operating system and the like. The native application may be configured to leverage the resources of the larger operating system and associated hardware via a set of predetermined rules which govern the operations of various operating systems and hardware resources. For example, where a native application desires to communicate with a device or network other than the mobile device or mobile operating system, the native application may leverage the communication protocol of the operating system and associated device hardware under the predetermined rules of the mobile operating system. Moreover, where the native application desires an input from a user, the native application may be configured to request a response from the operating system which monitors various hardware components and then communicates a detected input from the hardware to the native application.

The various system components may be independently, separately or collectively suitably coupled to the network via data links which includes, for example, a connection to an Internet Service Provider (ISP) over the local loop as is typically used in connection with standard modern communication, cable modem, Dish Networks®, ISDN, Digital Subscriber Line (DSL), or various wireless communication methods, see, e.g., GILBERT HELD, UNDERSTANDING DATA COMMUNICATIONS (19%), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Washington), MySQL by MySQL AB (Uppsala, Sweden), RethinkUB, or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GRIP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary. Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The computing unit of the first user device 102 and/or second user device 106 may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE® ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (for example, an IPv4 address of the form 123.56.789.234, an IPv6 address of the form 12.134.156.229.12.123, etc.). The web server retrieves the appropriate web pages and sends the data or applications for the web pages to the IP address. Web services are applications that are capable of interacting with other applications over a communications means, such as the internet. Web services are typically based on standards or protocols such as XML, SOAP, MAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia. Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography &. Network Security: Principles & Practice” by William Stallings, published by Prentice Hall; all of which are hereby incorporated by reference.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for managing a parking space, the method comprising:
registering a parking spot to a first user account in response to a registration request from a first user device, wherein the parking spot is associated with a parking descriptor;
receiving a street address data and associating the street address data with the parking spot, wherein the association is a one-to-many association with each of a plurality of parking spots associated with the street address data;
receiving a query including search criteria from a second user device associated with a second user account;
selecting the parking spot by matching the search criteria to the parking descriptor, returning the parking spot to the second user device; and
displaying a search result interface on the second user device with a parking icon associated with the parking spot.

2. The method of claim 1, further comprising receiving, from the second user device, a request to rent the parking spot for a selected period of time.

3. The method of claim 2, further comprising delivering, to the second user device, a message confirming rental of the parking spot to the second user account for the selected period of time.

4. The method of claim 3, further comprising receiving, from the second user account, payment for the rental of the parking spot for the selected period of time.

5. The method of claim 4, further comprising:
sending a message to the second user device, the message indicating that an allocated rental time for the parking spot is due to expire; and
after expiration of a grace period after the allocated rental time has completed, providing notification to a towing company regarding a vehicle that is parked in the parking spot for longer than the allocated rental time.

6. The method of claim 1, wherein the query from the second user device is a natural language search.

7. The method of claim 1, further comprising marking, in a database, the parking spot as available for rent responsive to GPS data received from the first user device indicating the first user device has departed the vicinity of the parking spot.

8. The method of claim 1, wherein the parking descriptor comprises at least one of covered, guarded, road side, driveway, garage, handicap, compact, commercial, residential, or lighted.

9. The method of claim 1, wherein the receiving, selecting, returning, and displaying are performed in real-time or near real-time.

10. The method of claim 1, further comprising parking a vehicle associated with the second user device in the parking spot.

11. The method of claim 5, further comprising towing, by the towing company and in response to the notification, the vehicle out of the parking spot to cause the parking spot to again be available for rent.

12. The method of claim 1, wherein the street address data is received from at least one of the first user device or the first user account and comprises a plain text input.

13. The method of claim 1 wherein receiving the street address data further comprises receiving a location data from an onboard sensor of the first user device and determining the street address data based on the location data.

14. The method of claim 13, further comprising generating a one-to-one association of the location data and the parking spot.

15. A system for generating precision geolocated parking spots comprising:
a processor,
a tangible, non-transitory memory configured to communicate with the processor,
the tangible, non-transitory memory having instructions stored thereon that, in response to execution by the processor, cause the processor to perform operations comprising:
registering, by the processor, a parking spot to a user account in response to a registration request from a first user device;
associating, by the processor, the parking spot with a parking descriptor;
receiving, by the processor, a first location data from the first user device; and
associating, by the processor, the first location data with the parking spot on a one-to-one basis and generating a precision geolocated parking spot.

16. The system of claim 15, wherein the associating the parking spot with a parking descriptor comprises:
generating, by the processor, a spot identifier and associating the identifier with the parking spot; and
populating, by he processor, a spot identifier field of a parking spot properties interface.

17. The system of claim 15, wherein receiving the first location data further comprises:
receiving, by the processor, a plain text longitude input and a plain text latitude input from a precision geolocation interface of the first user device and storing the plain text longitude input and the plain text latitude input as the first location data; or
receiving, by the processor, the first location data from an onboard sensor of the first user device in response to a pull command from the first user device.

18. The system of claim 17, wherein a longitude field and a latitude field of the precision geolocation interface are populated in response to the processor receiving the first location data from the onboard sensor of the first user device.

19. The system of claim 17, wherein the operations further comprise:
receiving, by the processor, a second location data from onboard sensors of a second user device;
determining, by the processor, a distance from the precision geolocated parking spot and the second user device based on the second location data; and
updating, by the processor, a distance display of a details panel of a search results interface based on the distance determined.
